(19) United States
(12) Patent Application Publication
(10) Pub. No.: US 2021/0035577 A1
(43) Pub. Date: Feb. 4, 2021

(54) CONTROL SYSTEM AND CONTROL METHOD

(71) Applicant: Panasonic Intellectual Property Management Co., Ltd., Osaka (JP)

(72) Inventors: Kiyonori KIDO, Osaka (JP); Keiichi TANAKA, Osaka (JP)

(21) Appl. No.: 16/967,992

(22) PCT Filed: Jan. 24, 2019
(86) PCT No.: PCT/JP2019/002353

§ 371 Date: Aug. 6, 2020

(30) Foreign Application Priority Data
Feb. 14, 2018 (JP) 2018-024287

(51) Int. Cl. G10L 15/22; G10L 15/28; G10L 15/24; G06F 3/16

(52) U.S. Cl. CPC G10L 15/22; G10L 15/28; G10L 2015/227; G06F 3/16; G10L 15/24

(57) ABSTRACT

A control system includes: a first communication unit configured to communicate with a speech control system that outputs speech control information for controlling a device based on a speech obtained by a speech input terminal; a second communication unit configured to obtain human information about presence or absence of a person within a predetermined area from which the speech input terminal obtains the speech; and an output unit configured to output, based on the human information obtained, control information for controlling a target device to be controlled.

### TECHNICAL FIELD

The present invention relates to a control system and a control method that control a device based on a speech.

### BACKGROUND ART

Services called virtual personal assistants (VPAs) are starting to become popular. As one form of such VPAs, there is a service which operates devices based on voices. Patent Literature (PTL) 1 discloses the home appliance control system in which a sound collecting device connectable to a network collects voice information, and controls a home appliance via the network, based on the voice information collected.

### CITATION LIST

### Patent Literature

PTL 1: WO 2014/171144

### SUMMARY OF THE INVENTION

### Technical Problem

In speech control systems, devices may be erroneously controlled based on speeches obtained against user's intention.

The present invention provides a control system and a control method that can prevent a device from being erroneously controlled.

### Solutions to Problem

A control system according to an aspect of the present invention includes: a communication unit configured to communicate with a speech control system that outputs speech control information for controlling a device based on a speech obtained by a speech obtaining unit; a human information obtaining unit configured to obtain human information about presence or absence of a person within a predetermined area from which the speech obtaining unit obtains the speech; and an output unit configured to output, based on the human information obtained, control information for controlling a target device to be controlled.

A control method according to an aspect of the present invention includes: communicating with a speech control system that outputs speech control information for controlling a device based on a speech obtained by a speech obtaining unit; obtaining human information about presence or absence of a person within a predetermined area from which the speech obtaining unit obtains the speech; and outputting, based on the human information obtained, control information for controlling a target device to be controlled.

A program according to an aspect of the present invention is a program for causing a computer to execute the control method.

### Advantageous Effect of Invention

According to the present invention, a control system and a control method that can prevent a device from being erroneously controlled are realized.

### BRIEF DESCRIPTION OF DRAWINGS

FIG. 1 is a block diagram illustrating a functional configuration of a speech recognition system according to Embodiment 1.

FIG. 2 is a flowchart illustrating Operation Example 1 of a control system according to Embodiment 1.

FIG. 3 is a flowchart illustrating Operation Example 2 of the control system according to Embodiment 1.

FIG. 4 is a block diagram illustrating a functional configuration of a speech recognition system according to Embodiment 2.

FIG. 5 is a block diagram illustrating a functional configuration of a speech recognition system according to Embodiment 3.

FIG. 6 is a flowchart illustrating Operation Example 1 of a control system according to Embodiment 3.

FIG. 7 is a flowchart illustrating Operation Example 2 of the control system according to Embodiment 3.

FIG. 8 is a block diagram illustrating a functional configuration of a speech recognition system according to Embodiment 4.

### DESCRIPTION OF EXEMPLARY EMBODIMENTS

Hereinafter, embodiments will be described in detail with reference to the drawings. Note that the embodiments below each describe a general or specific example. The numerical values, shapes, materials, elements, the arrangement and connection of the elements, steps, and the processing order of the steps, etc. presented in the embodiments below are mere examples and do not limit the present invention. Furthermore, among the structural elements in the following embodiments, structural elements not recited in any of the independent claims defining the most generic part of the inventive concept are described as optional structural elements.

Note that the drawings are schematic diagrams and do not necessarily provide strictly accurate illustrations. Throughout the drawings, the same sign is given to substantially the same configuration, and redundant description is omitted or simplified.

### Embodiment 1

### Configuration

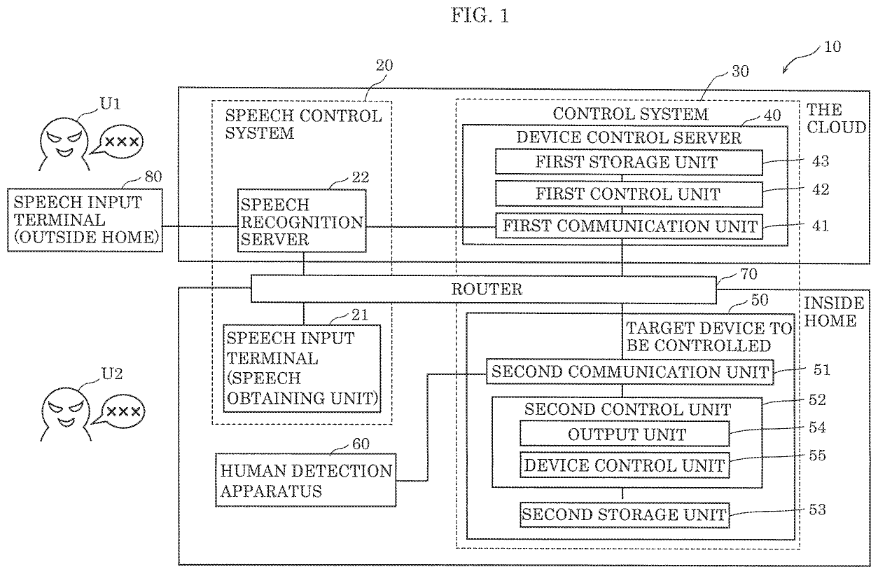

First, a configuration of a speech recognition system according to Embodiment 1 will be described. FIG. 1 is a block diagram illustrating a functional configuration of a speech recognition system according to Embodiment 1.

As illustrated in FIG. 1, speech recognition system 10 according to Embodiment 1 includes speech control system 20, control system 30, human detection apparatus 60, and router 70. Speech input terminal 21 of speech control system 20, target device to be controlled 50 of control system 30, human detection apparatus 60, and router 70 are provided inside a home. Speech recognition server 22 of speech control system 20 and device control server 40 of control system 30 each are realized as the cloud (cloud server). FIG. 1 also illustrates speech input terminal 80 provided outside the home.

### [Configuration of Speech Control System]

Speech control system 20 is a system for controlling a target device to be controlled using a speech as an input. Speech control system 20 includes speech input terminal 21 and speech recognition server 22.

Speech input terminal 21 is a speech input interface apparatus that obtains a speech uttered by, for example, a user inside the home. Speech input terminal 21 is one example of a speech obtaining unit. Speech input terminal 21 is, for example, a stationary terminal such as a smart speaker, but may be a mobile terminal such as a smartphone. Speech input terminal 21 may be any apparatus provided that speech input terminal 21 includes a speech collection apparatus such as a microphone and a communication circuit or the like that transmits a speech signal of a speech obtained to speech recognition server 22.

Router 70 is a relay apparatus that relays a local communication network used inside the home and a wide area network (e.g. a public network such as the Internet) used outside the home. For example, router 70 transmits a speech signal of a speech obtained by speech input terminal 21 to speech recognition server 22 in the cloud.

Speech recognition server 22 is a server that performs speech recognition processing on the speech signal transmitted from speech input terminal 21. A provider of a speech recognition service offers the speech recognition service using speech recognition server 22. Speech recognition server 22 converts the speech signal transmitted from speech input terminal 21 into, for example, text information, and then converts the text information into a command that corresponds to the text information. The command is one example of speech control information for controlling a device based on a speech obtained by speech input terminal 21. For example, when the text information indicates a text saying “turn on the air conditioner”, such text information is converted into a command for causing the air conditioner to start operation. In addition, speech recognition server 22 transmits the command to device control server 40 of control system 30.

### [Configuration of Control System]

Control system 30 is a system that controls, in cooperation with speech control system 20, a target device to be controlled provided inside the home. Control system 30 includes device control server 40 and target device to be controlled 50.

Device control server 40 is a server that controls target device to be controlled 50 inside the home, based on the command transmitted from speech recognition server 22. A provider of a device control service offers the device control service using device control server 40. Device control server 40 includes first communication unit 41, first control unit 42, and first storage unit 43.

First communication unit 41 communicates with speech control system 20. Specifically, first communication unit 41 obtains speech control information by communicating with speech control system 20. As described above, the speech control information is a command transmitted from speech recognition server 22, for example. First communication unit 41 is realized by, for example, a communication circuit.

First control unit 42 converts the command obtained by first communication unit 41 into an individualized command for controlling target device to be controlled 50 inside the home. In addition, first control unit 42 transmits the individualized command to target device to be controlled 50 via first communication unit 41. Note that speech recognition server 22 may transmit text information as speech control information, and first control unit 42 may convert the text information into a command and then convert the command into an individualized command. First control unit 42 is realized by, for example, a microcomputer or a processor.

First storage unit 43 is a storage apparatus that stores a program executed by first control unit 42. First storage unit 43 is realized by, for example, a semiconductor memory etc.

Target device to be controlled 50 is a device that receives the individualized command transmitted from first communication unit 41 of device control server 40, and operates according to the individualized command received. Target device to be controlled 50 is consumer electronics such as an air conditioner, but may be any device other than consumer electronics such as a locking apparatus of a fitting (e.g. a front door). In addition, besides target device to be controlled 50, control system 30 may include speech input terminal 21 as a target device to be controlled.

Such speech recognition system 10 may be targeted by malicious user U1 outside the home who, instead of a user in the home, attempts to remotely control target device to be controlled 50 using speech input terminal 80. Malicious user U2 may also attempt to input, to speech input terminal 21 inside the home, a speech uttered loudly from outside the home.

Accordingly, speech recognition system 10 includes human detection apparatus 60. Based on a detection result obtained by human detection apparatus 60, control system 30 controls target device to be controlled 50.

Human detection apparatus 60 detects the presence or absence of a person within a predetermined area (i.e. a predetermined area inside the home) from which speech input terminal 21 obtains a speech, and outputs human information about the presence or absence of a person. Human detection apparatus 60 may be realized as an individual apparatus or as a part of another apparatus. Human detection apparatus 60 is, for example, an apparatus that directly detects whether a person is present in the home.

Specifically, human detection apparatus 60 is a sensor that detects infrared rays emitted from a human body.

Human detection apparatus 60 may also be an apparatus that indirectly detects the presence of a person inside the home. In this case, human detection apparatus 60 may specifically be a locking apparatus of the front door. If this is the case, the presence of a person inside the home is estimated based on the locking state of the front door. For example, a person is estimated to be present inside the home when the front door is unlocked.

Human detection apparatus 60 may also be an electric power measurement apparatus that measures electric power consumption of the home. In this case, the presence of a person is estimated based on the power consumption information of the home. For example, a person is estimated to be present inside the home when the electric power consumption of the home exceeds a predetermined value. The locking state and the electric power consumption information are examples of life information.

Human detection apparatus 60 may be a speech collection apparatus different from speech input terminal 21. In this case, the presence of a person is estimated based on the state of obtainment of a speech. For example, a person is estimated to be present inside the home when a speech having at least a predetermined acoustic pressure level is obtained.

Human detection apparatus 60 may be a detection apparatus that detects an integration circuit (IC) tag which a user puts on, or an IC tag included in a mobile terminal which the user carries. Note that although human detection apparatus 60 can detect whether a particular person is present within the predetermined area when human detection apparatus 60 is a detection apparatus that can detect those IC tags, it is not necessary for human detection apparatus 60 to detect whether the particular person is present within the predetermined area.

### [Detailed Configuration of Target Device to be Controlled]

In Embodiment 1, target device to be controlled 50 performs information processing using human information. Hereinafter, a configuration of target device to be controlled 50 will be described in detail with continuous reference to FIG. 1. Target device to be controlled 50 includes second communication unit 51, second control unit 52, and second storage unit 53.

Second communication unit 51 receives, via router 70, an individualized command transmitted from first communication unit 41 of device control server 40. In addition, second communication unit 51 is one example of a human information obtaining unit. Second communication unit 51 obtains human information outputted from human detection apparatus 60 which indicates the presence or absence of a person within the predetermined area. Second communication unit 51 obtains the human information via a local communication network used inside the home. Second communication unit 51 is realized by, for example, a communication circuit. In FIG. 1, second communication unit 51 is illustrated in such a way that the human information is obtained from human detection apparatus 60 not via router 70, but it is to be noted that there may be a case where the human information is obtained via router 70. The above also applies to the following drawings.

Second control unit 52 includes output unit 54 and device control unit 55. Second control unit 52 is realized by, for example, a microcomputer, but may be realized by a processor.

Output unit 54 outputs, based on the human information obtained by second communication unit 51, control information for controlling target device to be controlled 50. For example, output unit 54 outputs, based on the speech control information obtained by first communication unit 41 (more specifically, the individualized command received by second communication unit 51) and the human information obtained by second communication unit 51, control information for controlling target device to be controlled 50.

Note that the human information obtained by second communication unit 51 as described above may indirectly indicate the presence or absence of a person within the predetermined area. In this case, output unit 54 performs processing to determine the presence or absence of a person using the human information.

Device control unit 55 operates target device to be controlled 50, based on the control information outputted from output unit 54. When target device to be controlled 50 is an air conditioner, device control unit 55 operates target device to be controlled 50 to air-condition the home, based on the control information outputted from output unit 54.

Second storage unit 53 is a storage apparatus that stores a program etc. executed by second control unit 52. Specifically, second storage unit 53 is realized by a semiconductor memory etc.

### Operation Example 1 of Control System

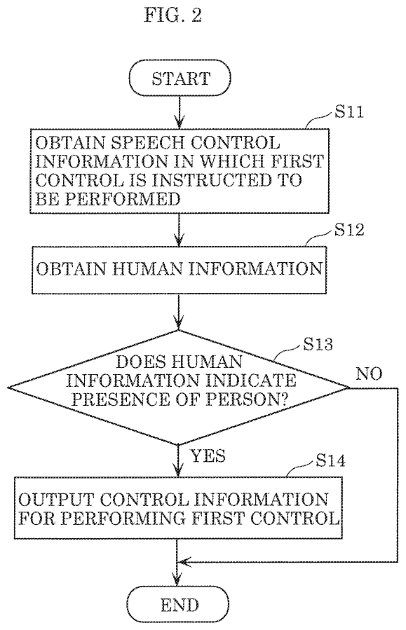

Next, Operation Example 1 of control system 30 will be described. FIG. 2 is a flowchart illustrating Operation Example 1 of control system 30 according to Embodiment 1.

First, first communication unit 41 obtains, by communicating with speech control system 20, speech control information in which first control is instructed to be performed (S11). In addition, second communication unit 51 obtains, from human detection apparatus 60, human information about the presence or absence of a person within a predetermined area from which speech input terminal 21 obtains a speech (S12).

Next, output unit 54 determines whether the human information obtained in step S12 indicates the presence of a person within the predetermined area (S13). Output unit 54 determines whether the human information indicates the presence of a person within the predetermined area at the time of obtaining the speech control information, for example.

When output unit 54 determines that the human information indicates the presence of a person within the predetermined area (YES in S13), output unit 54 outputs control information for performing the first control on target device to be controlled 50 (S14). For example, when target device to be controlled 50 is an air conditioner, and when the first control is the control for turning on the air conditioner, output unit 54 outputs control information for turning on target device to be controlled 50 (i.e. air conditioner).

On the contrary, when output unit 54 determines that the human information indicates the absence of a person within the predetermined area (NO in S13), output unit 54 does not output the control information for performing the first control on target device to be controlled 50. That is, when the speech control information obtained in step S11 is estimated to be not based on a speech uttered by a person present inside the home, output unit 54 does not follow the speech control information in which the first control is instructed to be performed, and ignores the speech control information.

With such Operation Example 1, target device to be controlled 50 is prevented from being controlled by a speech uttered by a user (e.g. user U1 or user U2) outside the home. That is, control system 30 can prevent target device to be controlled 50 from being erroneously controlled against an intention that a user present inside the home has.

### Operation Example 2 of Control System

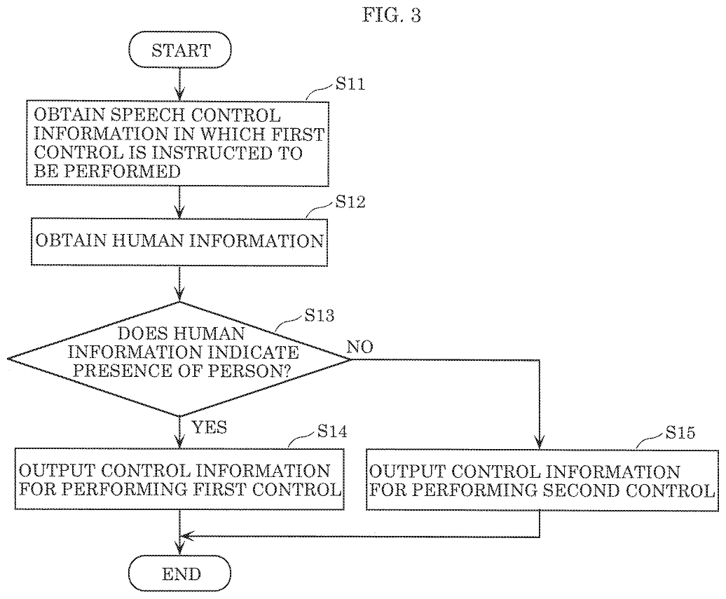

Next, Operation Example 2 of control system 30 will be described. FIG. 3 is a flowchart illustrating Operation Example 2 of control system 30.

In the same manner as Operation Example 1, first communication unit 41 obtains speech control information in which first control is instructed to be performed (S11), and second communication unit 51 obtains human information from human detection apparatus 60 (S12).

Output unit 54 determines whether the human information obtained in step S12 indicates the presence of a person within a predetermined area (S13).

When output unit 54 determines that the human information indicates the presence of a person within the predetermined area (YES in S13), output unit 54 outputs control information for performing the first control on device control unit 55 of target device to be controlled 50 (S14). For example, when target device to be controlled 50 is an air conditioner, and when the first control is the control which causes the air conditioner to air-condition the home at 25° C., output unit 54 outputs the control information for causing target device to be controlled 50 (i.e. air conditioner) to air-condition the home at 25° C.

On the contrary, when output unit 54 determines that the human information indicates the absence of a person within the predetermined area (NO in S13), output unit 54 outputs control information for performing second control on target device to be controlled 50 (S15). The second control is different from the first control instructed to be performed in the speech control information obtained in step S11. That is, when the speech control information obtained in step S11 is estimated to be not based on a speech uttered by a person present inside the home, output unit 54 does not follow the speech control information, and modifies the detail of control to be performed.

For example, when target device to be controlled 50 is an air conditioner, and when the first control is the control which causes the air conditioner to air-condition the home at 25° C., the second control is the control which causes the air conditioner to air-condition the home at 28° C. That is, since a person is estimated to be absent from the home, output unit 54 modifies the detail of the control to be performed so as to avoid excessive air conditioning (reduction in electric power consumption). In other words, output unit 54 changes the detail of the control instructed to be performed in the speech control information to the detail of control which responds to a situation in which a person is absent from the home.

With such Operation Example 2, target device to be controlled 50 is prevented from performing inappropriate operation when a person is estimated to be absent from the home.

### Variation

Note that first communication unit 41 may obtain information about a direction from which a speech obtained by speech input terminal 21 is uttered.

Output unit 54 may output control information, based on the information about the direction from which a speech is uttered and human information.

In this case, the direction from which a speech is uttered is detected by a sensor included in speech input terminal 21, and a speech input terminal generates information about an input of the speech. Speech input terminal 21 transmits, to speech recognition server 22, the information about the direction from which the speech obtained is uttered in addition to a speech signal of the speech obtained.

The information about the direction from which the speech is uttered is obtained by first communication unit 41. For example, when the information about the direction from which the speech is uttered is used in the above Operation Example 1, the direction from which the speech is uttered is required to be a predetermined direction in order for first control to be performed. That is, the first control is performed when human information indicates the presence of a person within the predetermined area, and when the direction which the information about the direction from which the speech is uttered indicates is the predetermined direction.

In addition, first communication unit 41 may obtain information about loudness (specifically, acoustic pressure) of a speech obtained by speech input terminal 21. Output unit 54 may output control information, based on the information about the loudness of a speech and human information.

In this case, the loudness of a speech is detected by a sensor included in speech input terminal 21, and a speech input terminal generates information about an input of the speech. Speech input terminal 21 transmits, to speech recognition server 22, information about the loudness of the speech obtained in addition to a speech signal of the speech obtained.

The information about the loudness of a speech is obtained by first communication unit 41. For example, when information about the loudness of the speech is used in the above Operation Example 1, the loudness indicated in the information about the loudness of the speech is required to be at least predetermined loudness in order for first control to be performed. That is, the first control is performed when human information indicates the presence of a person within the predetermined area, and when the loudness which information about the loudness of the speech indicates is at least the predetermined loudness.

### Embodiment 2

### Configuration

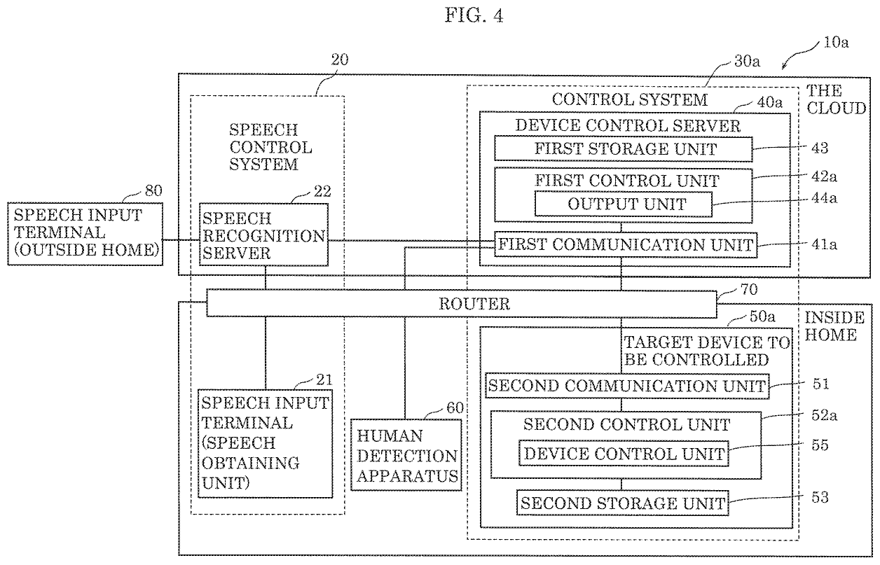

Next, a configuration of a speech recognition system according to Embodiment 2 will be described. FIG. 4 is a block diagram illustrating a functional configuration of a speech recognition system according to Embodiment 2. Note that following Embodiment 2 mainly describes differences from Embodiment 1, and thus the description of items that have already been described will be omitted or simplified. This also applies to other embodiments from Embodiment 3 onward.

As illustrated in FIG. 4, control system 30a included in speech recognition system 10a according to Embodiment 2 includes device control server 40a and target device to be controlled 50a.

In Embodiment 2, device control server 40a performs information processing using human information. Device control server 40a includes first communication unit 41a, first control unit 42a, and first storage unit 43.

First communication unit 41a communicates with speech control system 20. Specifically, first communication unit 41a obtains speech control information by communicating with speech control system 20. In addition, first communication unit 41a is one example of a human information obtaining unit. First communication unit 41a obtains, by communicating with human detection apparatus 60, human information outputted from human detection apparatus 60 which indicates the presence or absence of a person within a predetermined area. First communication unit 41a is realized by, for example, a communication circuit.

First control unit 42a includes output unit 44a. First control unit 42a is realized by, for example, a microcomputer or a processor. Output unit 44a converts a control command obtained by first communication unit 41 into an individualized command for controlling target device to be controlled 50a provided inside a home.

Output unit 44a also outputs, based on the human information obtained by first communication unit 41a, control information for controlling target device to be controlled 50a. Specifically, output unit 44a ceases output of the control information as described in FIG. 2, and modifies control information (detail of control to be performed) as described using FIG. 3. The control information described here is the individualized command described above.

When output unit 44a outputs the control information, first communication unit 41a transmits the control information to target device to be controlled 50a. When second communication unit 51 of target device to be controlled 50a receives the control information, device control unit 55 included in second control unit 52a operates target device to be controlled 50a, based on the control information received.

As described above, instead of target device to be controlled 50a, device control server 40a performs information processing using human information in speech recognition system 10a. That is, a change made to the specifications of device control server 40a can, for example, cease the control performed on a device based on a speech when the person is absent from the home. In other words, it is possible to cease the control performed on a device based on a speech when the person is absent from the home, while the scale of changes made to the specifications of target device to be controlled 50a is suppressed.

### Embodiment 3

### Configuration

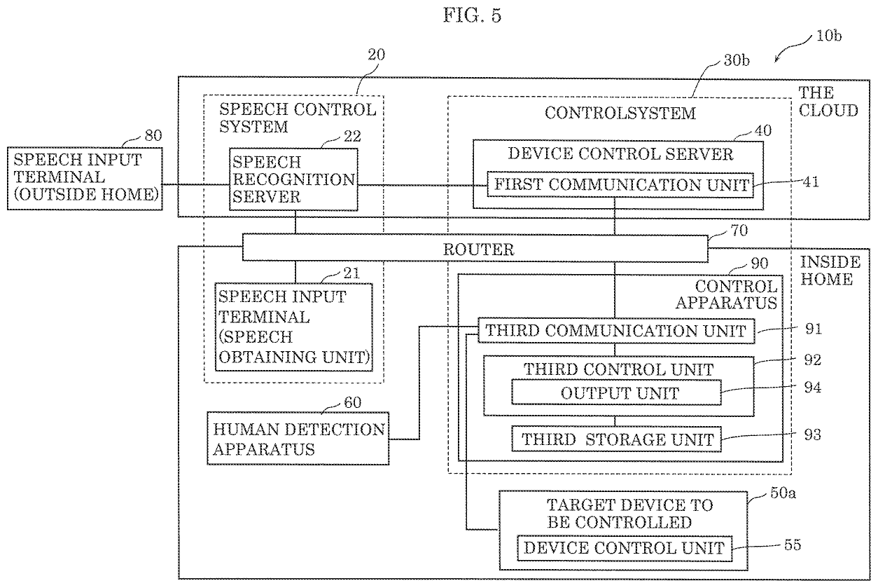

Next, a configuration of a speech recognition system according to Embodiment 3 will be described. FIG. 5 is a block diagram illustrating a functional configuration of a speech recognition system according to Embodiment 3. Note that in FIG. 5, the functional configuration of device control server 40 and the functional configuration of target device to be controlled 50a are simplified.

As illustrated in FIG. 5, control system 30b included in speech recognition system 10b according to Embodiment 3 includes device control server 40, control apparatus 90, and target device to be controlled 50a. In Embodiment 3, control apparatus 90 performs information processing using human information.

Control apparatus 90 is an apparatus that controls a device inside a home. Control apparatus 90 is, for example, a home energy management system (HEMS) controller (i.e. a home gateway). Control apparatus 90 includes third communication unit 91, third control unit 92, and third storage unit 93.

Third communication unit 91 receives, via router 70, an individualized command transmitted from first communication unit 41 of device control server 40. In addition, third communication unit 91 is one example of a human information obtaining unit. Third communication unit 91 obtains human information outputted from human detection apparatus 60 which indicates the presence or absence of a person within a predetermined area. Third communication unit 91 obtains the human information via a local communication network used inside a home. Third communication unit 91 is realized by, for example, a communication circuit.

Third control unit 92 includes output unit 94. Third control unit 92 is realized by, for example, a microcomputer, but may be realized by a processor.

Output unit 94 outputs, based on speech control information obtained by first communication unit 41 (more specifically, an individualized command received by third communication unit 91) and human information obtained by third communication unit 91, control information for controlling target device to be controlled 50a.

Note that the human information obtained by third communication unit 91 as described above may indirectly indicate the presence or absence of a person within the predetermined area. In this case, output unit 94 performs processing to determine the presence or absence of a person using the human information.

Third storage unit 93 is a storage apparatus that stores a program etc. executed by third control unit 92. Specifically, third storage unit 93 is realized by a semiconductor memory etc.

When output unit 94 outputs control information, third communication unit 91 transmits the control information to target device to be controlled 50a via the local communication network used inside the home. When second communication unit 51 (not illustrated in FIG. 5) of target device to be controlled 50a receives the control information, device control unit 55 operates target device to be controlled 50a, based on the control information received.

### Operation Example 1 of Embodiment 3

In control system 30b, control apparatus 90 performs information processing using human information. Specifically, output unit 94 of control apparatus 90 ceases the output of the control information as described in FIG. 2, and modifies the control information (detail of control to be performed) as described using FIG. 3.

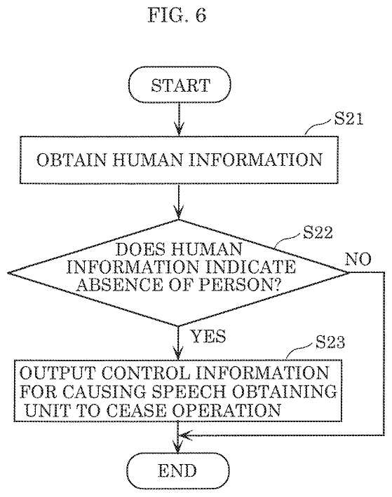

In addition, speech input terminal 21 may be a target device to be controlled in control system 30b. That is, output unit 94 in control system 30b may output, based on speech control information and human information, control information for controlling speech input terminal 21. FIG. 6 is a flowchart illustrating Operation Example 1 of such control system 30b.

In Operation Example 1, speech input terminal 21 is supposed to be in operation and a person is supposed to be present inside a home in the beginning.

First, third communication unit 91 obtains, from human detection apparatus 60, human information about the presence or absence of the person within a predetermined area from which speech input terminal 21 obtains a speech (S21).

Next, output unit 94 determines whether the human information obtained in step S21 indicates the absence of the person (S22). Specifically, output unit 94 determines whether the human information which had been indicating the presence of the person has changed to indicate the absence of the person.

When output unit 94 determines that the human information indicates the absence of the person (YES in S22), output unit 94 outputs control information for causing speech input terminal 21 to cease operation (S23).

The control information outputted is transmitted from third communication unit 91 to speech input terminal 21 via a local communication network used inside the home. Accordingly, when the person is estimated to be absent from the home, the control performed on target device to be controlled 50a based on a speech obtained via speech input terminal 21 is caused to cease.

Note that causing speech input terminal 21 to cease operation means to cease at least the output of a speech signal from speech input terminal 21 to speech recognition server 22. The output of a speech signal can be ceased in any manner. The output of a speech signal may be ceased by (i) turning off the power source of speech input terminal 21, (ii) turning off the power source of a microphone included in speech input terminal 21 or muting the microphone, and (iii) turning off a communication circuit that outputs (transmits) the speech signal.

On the contrary, when output unit 94 determines that the human information indicates the presence of the person (NO in S22), output unit 94 does not output the control information for causing speech input terminal 21 to cease operation. Consequently, the operation of speech input terminal 21 continues.

With such Operation Example 1, target device to be controlled 50a is prevented from being controlled by a speech uttered by a user outside the home when the person is absent from the home. Speech input terminal 21 is also prevented from malfunctioning when the person is absent from the home.

### Operation Example 2 of Embodiment 3

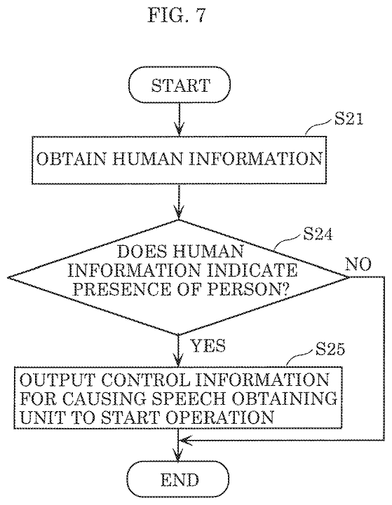

FIG. 7 is a flowchart illustrating Operation Example 2 of control system 30b. In Operation Example 2, speech input terminal 21 is supposed to be not in operation and the person is supposed to be absent from the home in the beginning.

First, third communication unit 91 obtains, from human detection apparatus 60, human information about the presence or absence of the person within the predetermined area from which speech input terminal 21 obtains a speech (S21). Next, output unit 94 determines whether the human information obtained in step S21 indicates the presence of the person (S24).

Specifically, output unit 94 determines whether the human information which had been indicating the absence of the person has changed to indicate the presence of the person.

When output unit 94 determines that the human information indicates the presence of the person (YES in S24), output unit 94 outputs control information for causing speech input terminal 21 to start operation (S25). The control information outputted is transmitted from third communication unit 91 to speech input terminal 21 via a local communication network used inside the home. Accordingly, when the person is estimated to be present inside the home, the control performed on target device to be controlled 50a based on a speech obtained via speech input terminal 21 is allowed.

On the contrary, when output unit 94 determines that the human information indicates the presence of the person (NO in S24), output unit 94 does not output the control information for causing speech input terminal 21 to start operation. Consequently, the operation of speech input terminal 21 continues to cease.

With such Operation Example 2, the control performed on target device to be controlled 50a based on a speech obtained via speech input terminal 21 resumes when the person is estimated to be present in the home.

### Embodiment 4

### Configuration

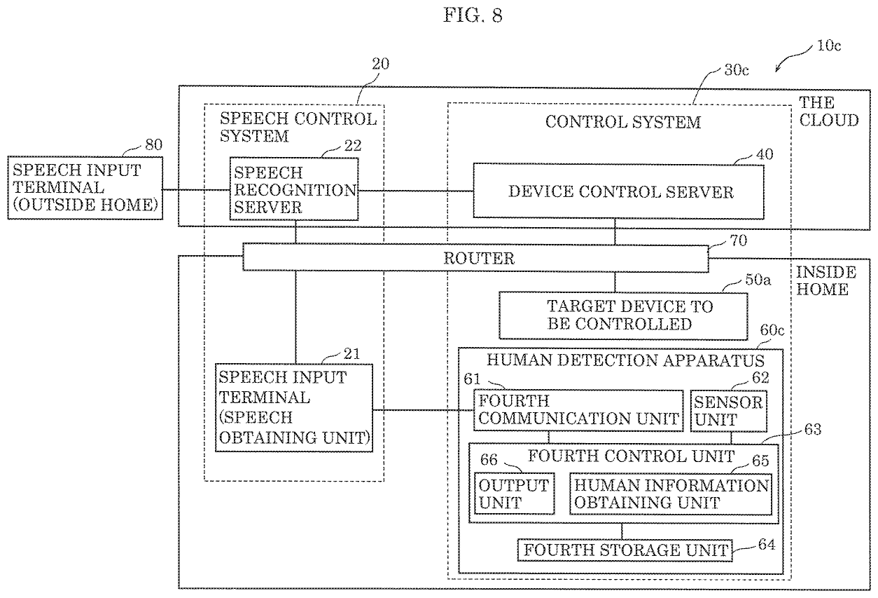

Next, a configuration of a speech recognition system according to Embodiment 4 will be described. FIG. 8 is a block diagram illustrating a functional configuration of a speech recognition system according to Embodiment 4. Note that in FIG. 8, the functional configuration of device control server 40 and the functional configuration of target device to be controlled 50a are simplified.

As illustrated in FIG. 8, control system 30c included in speech recognition system 10c according to Embodiment 4 includes device control server 40, target device to be controlled 50a, and human detection apparatus 60c. Human detection apparatus 60c includes fourth communication unit 61, sensor unit 62, fourth control unit 63, and fourth storage unit 64.

Fourth communication unit 61 communicates with speech control system 20. Specifically, fourth communication unit 61 communicates with speech input terminal 21 of speech control system 20 via a local communication network used inside a home. Fourth communication unit 61 is realized by, for example, a communication circuit.

Sensor unit 62 detects the presence or absence of a person within a predetermined area (i.e. a predetermined area inside the home) from which speech input terminal 21 obtains a speech by detecting whether the person is present inside the home, and outputs human information about the presence or absence of the person. Like human detection apparatus 60 described above, a specific aspect of sensor unit 62 is not limited. Sensor unit 62 is to be an apparatus which directly or indirectly detects whether the person is present inside the home.

Fourth control unit 63 includes human information obtaining unit 65 and output unit 66. Fourth control unit 63 is realized by, for example, a microcomputer, but may be realized by a processor.

Human information obtaining unit 65 obtains human information outputted from sensor unit 62. Output unit 66 outputs, based on the human information obtained by human information obtaining unit 65, control information for controlling speech input terminal 21.

For example, when the human information indicates the absence of a person within the predetermined area, output unit 66 outputs the control information for causing speech input terminal 21 to cease operation. The control information outputted is transmitted from fourth communication unit 61 to speech input terminal 21. Accordingly, in the same manner as Operation Example 1 of Embodiment 3, the control performed on target device to be controlled 50a based on a speech obtained via speech input terminal 21 is caused to cease when the person is estimated to be absent from the home.

In addition, output unit 66 outputs the control information for causing speech input terminal 21 to start operation when the human information indicates the presence of the person within the predetermined area. The control information outputted is transmitted from fourth communication unit 61 to speech input terminal 21. Accordingly, in the same manner as Operation Example 2 of Embodiment 3, the control performed on target device to be controlled 50a based on a speech obtained via speech input terminal 21 is caused to resume when the person is estimated to be present inside the home.

Fourth storage unit 64 is a storage apparatus that stores a program etc. executed by fourth control unit 63. Specifically, fourth storage unit 64 is realized by a semiconductor memory etc.

As described above, instead of device control server 40 and target device to be controlled 50a, human detection apparatus 60c performs information processing using human information in speech recognition system 10c. That is, the introduction of human detection apparatus 60c allows a device controlled based on a speech to, for example, cease when the person is absent from the home. In other words, it is possible to cease the control performed on a device based on a speech when the person is absent from the home, while the scale of changes made to the specifications of device control server 40 and target device to be controlled 50a is suppressed.

(Advantageous effects etc.) As described above, control system 30 includes: first communication unit 41 that communicates with speech control system 20 which outputs speech control information for controlling a device based on a speech obtained by speech input terminal 21; second communication unit 51 that obtains human information about presence or absence of a person within a predetermined area from which speech input terminal 21 obtains the speech; and output unit 54 that outputs, based on the human information obtained, control information for controlling target device to be controlled 50. Speech input terminal 21 is one example of a speech obtaining unit, and second communication unit 51 is one example of a human information obtaining unit.

Such control system 30 can change, based on whether a person is around speech input terminal 21, the detail of control to be performed on target device to be controlled 50. Therefore, it is possible to prevent the device from being erroneously controlled.

In addition, for example, first communication unit 41 obtains the speech control information by communicating with speech control system 20, and output unit 54 outputs the control information, based on the speech control information obtained and the human information obtained.

Such control system 30 can change, based on whether a person is around speech input terminal 21, the detail of control to be performed on target device to be controlled 50 which is instructed to be performed in speech control information.

In addition, for example, when first communication unit 41 obtains the speech control information, output unit 54 outputs, based on the human information obtained, the control information for performing second control on target device to be controlled 50. The second control is different from first control instructed to be performed in the speech control information.

Such control system 30 can change, based on whether a person is around speech input terminal 21, the control to be performed on target device to be controlled 50 from the first control to the second control.

In addition, for example, when the communication unit obtains the speech control information, output unit 54 outputs (i) the control information for performing the first control on target device to be controlled 50 when the human information obtained indicates the presence of a person within the predetermined area, and (ii) the control information for performing the second control on target device to be controlled 50 when the human information obtained indicates the absence of a person within the predetermined area.

Such control system 30 can change the control to be performed on target device to be controlled 50 from the first control to the second control when a person is not present around speech input terminal 21.

In addition, a target device to be controlled includes speech input terminal 21 in control system 30b. Output unit 94 outputs, based on the human information obtained, the control information for controlling speech input terminal 21.

Such control system 30b can control speech input terminal 21 based on whether a person is around speech input terminal 21.

In addition, for example, when the human information obtained indicates the absence of a person within the predetermined area, output unit 94 outputs control information for causing speech input terminal 21 to cease operation.

Such control system 30b can cease the operation of speech input terminal 21 when a person is not present around speech input terminal 21.

Therefore, when the person is absent from a home, target device to be controlled 50a is prevented from controlled by a speech uttered by, for example a user outside the home. Furthermore, when the person is absent from the home, speech input terminal 21 is prevented from malfunctioning.

In addition, for example, when the human information obtained indicates the presence of a person within the predetermined area, output unit 94 outputs control information for causing speech input terminal 21 to start operation.

Such control system 30b can resume, based on a speech obtained via speech input terminal 21, the control performed on target device to be controlled 50a when a person is estimated to be present inside a home.

### Other Embodiments

The above has described the embodiments, yet the present invention is not limited to the above embodiments.

For example, the communication methods of communicating among apparatuses which are described in the above embodiments are not particularly limited to the above. For example, the wireless communication performed among apparatuses uses a communication standard such as specified low power radio, ZigBee (registered trademark), Bluetooth (registered trademark), or Wi-Fi (registered trademark). Note that the wireless communication is specifically radio communication or infrared communication, for example.

Instead of the wireless communication, wired communication may be performed among the apparatuses. Such wired communication may be power line communication (PLC), or communication performed using a wired LAN. The communication performed among the apparatuses may also be a combination of wireless communication and wired communication.

Furthermore, a process performed by a particular processing unit in the above embodiments may be performed by another processing unit. Moreover, the order of processes may be changed, and the processes may be performed in parallel.

In addition, the structural elements such as a control unit may be realized by executing a software program suitable for each structural element.

Each structural element may be realized by means of a program executing unit, such as a CPU or a processor, reading and executing a software program recorded on a recording medium such as a hard disk or a semiconductor memory.

In addition, the structural elements such as a control unit may be realized by a hardware product. For example, the structural elements such as the control unit may be circuits or integrated circuits. These circuits may constitute a single circuit as a whole or may be individual circuits.

Furthermore, each of these circuits may be a general-purpose circuit or may be a dedicated circuit.

Note that the general or specific aspects of the present invention may be realized by a system, an apparatus, a method, an integrated circuit, a computer program, or a computer-readable recording medium such as a CD-ROM. The general or specific aspects of the present invention may also be realized by any combination of a system, an apparatus, a method, an integrated circuit, a computer program, and a recording medium.

For example, the present invention may be realized as a target device to be controlled, a device control server, a control apparatus, or a human detection apparatus. In addition, the present invention may be realized as a control method, a program for causing a computer to execute the control method, and a non-transitory computer-readable recording medium on which such a program is recorded.

Each of the systems described above may be realized as a single apparatus, and may also be realized by a plurality of apparatuses. When each system is realized by a plurality of apparatuses, the structural elements included in the systems described in the above embodiments may be allotted to the plurality of apparatuses in any manner.

The present invention also encompasses: embodiments achieved by applying various modifications conceivable to those skilled in the art to each embodiment; and embodiments achieved by optionally combining the structural elements and the functions of each embodiment without departing from the essence of the present invention.

### REFERENCE MARKS IN THE DRAWINGS

20 speech control system
21 speech input terminal (speech obtaining unit)
22 speech recognition server
30, 30a, 30b, 30c control system
41 first communication unit (communication unit)
41a first communication unit (communication unit, human information obtaining unit)
44a, 54, 66, 94 output unit
50 50a target device to be controlled
51 second communication unit (human information obtaining unit)
61 fourth communication unit (communication unit)
65 human information obtaining unit
91 third communication unit (human information obtaining unit)

1. A control system, comprising:
a communication unit configured to communicate with a speech control system that outputs speech control information for controlling a device based on a speech obtained by a speech obtaining unit;
a human information obtaining unit configured to obtain human information about presence or absence of a person within a predetermined area from which the speech obtaining unit obtains the speech; and
an output unit configured to output, based on the human information obtained, control information for controlling a target device to be controlled.

2. The control system according to claim 1, wherein
the communication unit is configured to obtain the speech control information by communicating with the speech control system, and
the output unit is configured to output the control information, based on the speech control information obtained and the human information obtained.

3. The control system according to claim 2, wherein
when the communication unit obtains the speech control information, the output unit is configured to output, based on the human information obtained, the control information for performing second control on the target device to be controlled, the second control being different from first control instructed to be performed in the speech control information.

4. The control system according to claim 3, wherein
when the communication unit obtains the speech control information, the output unit is configured to:
output the control information for performing the first control on the target device to be controlled when the human information obtained indicates the presence of a person within the predetermined area; and
output the control information for performing the second control on the target device to be controlled when the human information obtained indicates the absence of a person within the predetermined area.

5. The control system according to claim 1, wherein
the target device to be controlled includes the speech obtaining unit, and
the output unit is configured to output, based on the human information obtained, the control information for controlling the speech obtaining unit.

6. The control system according to claim 5, wherein
when the human information obtained indicates the absence of a person within the predetermined area, the output unit is configured to output control information for causing the speech obtaining unit to cease operation.

7. The control system according to claim 5, wherein
when the human information obtained indicates the presence of a person within the predetermined area, the output unit is configured to output control information for causing the speech obtaining unit to start operation.

8. A control method, comprising:
communicating with a speech control system that outputs speech control information for controlling a device based on a speech obtained by a speech obtaining unit;
obtaining human information about presence or absence of a person within a predetermined area from which the speech obtaining unit obtains the speech; and
outputting, based on the human information obtained, control information for controlling a target device to be controlled.

9. A non-transitory computer-readable recording medium for use in a computer, the recording medium having a computer program recorded thereon for causing the computer to execute the control method according to claim 8.
